(19) United States
(12) Patent Application Publication
(10) Pub. No.: US 2026/0158614 A1
(43) Pub. Date: Jun. 11, 2026

(54) HIGH PRESSURE WATER JET CUTTING APPARATUS AND METHOD FOR ROCK-WALL CRANE GIRDER IN UNDERGROUND CAVERN POWERHOUSE

(71) Applicant: SHANDONG UNIVERSITY, Jinan (CN)

(72) Inventors: Bin LIU, Jinan (CN); Biao Li, Jinan (CN); Jiwen Wang, Jinan (CN); Bo Zhang, Jinan (CN); Hanxu Li, Jinan (CN); Yijiu Xu, Jinan (CN)

(73) Assignee: SHANDONG UNIVERSITY, Jinan (CN)

(21) Appl. No.: 19/178,971

(22) Filed: Apr. 15, 2025

(30) Foreign Application Priority Data
Apr. 15, 2024 (CN) 202410449804.3

(51) Int. Cl. B24C 5/04; B24C 3/06; B24C 7/00

(52) U.S. Cl. CPC B24C 5/04; B24C 3/06; B24C 7/0015

(57) ABSTRACT

Provided is a high pressure water jet cutting apparatus for a rock-wall crane girder in an underground cavern powerhouse, comprising: a guiding mechanism, a support mechanism, and a jet cutting mechanism, where the guiding mechanism is detachably connected to a steel tube frame, the steel tube frame is erected according to drilling positions, and the support mechanism is connected to the guiding mechanism and is capable of moving on the guiding mechanism; and the support mechanism is connected to the jet cutting mechanism, the support mechanism is configured to adjust an angle of a hollow jet pipeline protection tube of the jet cutting mechanism, a tail end of the hollow jet pipeline protection tube is connected with a nozzle, and the steel tube frame is connected to a positioning steel tube through which the hollow jet pipeline protection tube passes.

### CROSS REFERENCE TO RELATED APPLICATION

The present invention claims priority benefits Chinese patent application with an application number 202410449804.3 and entitled “High pressure water jet cutting apparatus and method for rock-wall crane girder in underground cavern powerhouse”, filed on Apr. 15, 2024, with the China National Intellectual Property Administration, the entire contents of which are incorporated into the present invention by reference and form part of the present invention for all purposes.

### TECHNICAL FIELD

The present invention relates to the technical field of water conservancy and hydropower engineering, especially to the technical field of high pressure water jet cutting. Specifically, it relates to a high pressure water jet cutting apparatus for a rock-wall crane girder in an underground cavern powerhouse and a high pressure water jet cutting method for a rock-wall crane girder in an underground cavern powerhouse.

### BACKGROUND

The statements in this section merely provide background art related to the present invention and do not necessarily constitute the prior art.

In construction of water conservancy and hydropower projects, rock-wall crane girders are designed in underground cavern powerhouses. A rock-wall crane girder is a special structural form of an underground cavern powerhouse of a hydropower station. A reinforced concrete girder is fixed to a rock-wall through a grouting bolt, and a large-scale bridge crane is arranged on it. It can be used for civil engineering concrete construction and installation and maintenance of a metal structure and electromechanical equipment. All loads borne by a girder body are transmitted to a surrounding rock through a contact surface between the bolt and concrete and a rock bench. The rock-wall crane girder can make full use of a bearing capacity of the surrounding rock of a cavern; eliminate a need for crane support columns, and save consumption of steel bars and concrete. Since there is no support column in the powerhouse, a span of the underground cavern powerhouse can be reduced, and an excavation workload can be saved, which is beneficial to overall stability of the surrounding rock. The rock-wall crane girder is an important part of the underground cavern powerhouse of a pumped-storage power station and has a top priority in quality control. Its construction quality directly affects an operation safety of the hydropower station.

At present, the construction of the rock-wall crane girders in the underground cavern powerhouses mostly adopts a drill-blasting method. In order to control blasting accuracy, a method of close-range and small-dose explosion is often utilized, that is, blasting holes with a spacing of 30 cm are arranged, and small-dose explosives are filled for blasting one by one. Subsequently, manual trimming is carried out according to a blasted section to maintain an overall structure. The conventional blasting method has a low degree of mechanization. It is difficult to control a forming quality due to an influence of a geological condition. Moreover, the blasting generates a large number of tiny cracks, which reduces stability of the surrounding rock and causes certain damage to the rock-wall, affecting a project safety. In addition, it also has problems such as relying on manual excavation and blasting, high labor intensity, a slow speed, and significant over-excavation and under-excavation. Excavation of rock-anchor girders has high requirements for a forming quality and integrity of a rock after blasting, and the conventional blasting method obviously does not meet the requirements. A water jet cutting method has high control accuracy for the forming quality and a good flatness of the rock-wall cutting, which can reduce a secondary operation and improve a construction quality of rock-anchor girder excavation. At the same time, it can reduce disturbance to rock mass of the rock-wall and avoid damage to the rock-wall, which is more conducive to a stress stability of the overall structure of the rock-wall girder. At present, a maximum thickness of a rock cut by high pressure water jets is about 30 cm-50 cm. Considering 30 cm-spaced drilled holes required for the construction of rock-wall crane girders in the underground cavern powerhouses, a jet mechanism can be extended into holes to cut the rock-wall. Therefore, after comprehensive consideration, a construction method of high pressure abrasive water jets is adopted.

A length of the underground cavern powerhouse of the pumped-storage power station may reach hundreds of meters. If a traditional single-pipeline jet mechanism is used to extend into the holes one by one, cutting efficiency is low. At the same time, considering a limited construction accuracy of on-site drilling of holes, when the single-pipeline jet mechanism is extended into the holes for cutting, it is difficult to refer to a cutting path of a previous hole, and a cutting surface may be misaligned, affecting the flatness of the cut rock-wall. Therefore, a double-pipeline jet mechanism is utilized to emit opposite jets for cutting, which can ensure unity of a cutting plane and the construction efficiency and flatness.

However, the inventor found that there is currently no precedent for application of a high pressure water jet system in the cutting construction of the rock-wall crane girders. Therefore, there are still many problems to be solved when applying the jets for the cutting construction, which are specifically reflected in:
(1) The jet mechanism needs to move along an arrangement direction of the drilled holes for construction, and it is necessary to ensure that the two jet-protecting steel tubes are at the same position when they are extended into the same hole as much as possible. However, uneven ground may cause excessive errors and affect the construction quality. If a special ground construction treatment is carried out, the cost is too high. Meanwhile, if manual movement is used for each step, a movement speed is too slow, which may affect the construction efficiency.
(2) A cross-sectional shape of a cutting part of the rock-anchor girder construction is a right-angled trapezoid. Cutting work needs to be divided into vertical cutting and inclined cutting. A design of a cutting apparatus needs to consider applicability of cutting work at different angles. Meanwhile, the apparatus needs to be easy to be operated and adjusted. Existing equipment cannot automatically adjust to adapt to the cutting work at various angles.
(3) The construction accuracy of the on-site drilling of holes is not high. When the two jet-protecting steel tubes are extended into hole openings at the same time, they may get stuck in the holes due to differences in hole spacing and angle, and it is difficult for them to be accurately extended into the holes for cutting operations.
(4) Nozzles on the market currently are of a one-word type, that is, a water supply tube and the nozzles are in the same straight line. There is a lack of L-shaped nozzles for lateral diversion. In addition, when the jet mechanism is extended into the holes for cutting, due to the opposite jets emitted among the nozzles, high pressure water may spray onto an opposite nozzle, affecting a service life of the nozzle.
(5) During the jet cutting, dust, rock debris, etc. are easily generated on-site. It is difficult to discharge them in the underground cavern, which not only blocks the line of sight, affects the construction efficiency, but also seriously affects life and health of a construction worker.
(6) When high pressure jets cut a rock, a jet pressure may reach dozens or even hundreds of megapascals, which is very powerful and may cause harm to lives and health of surrounding people. Therefore, when the mechanism is operating, people need to stay away from the jet mechanism as much as possible. However, most of the existing cutting methods require a lot of manual close-range contacts.
(7) Currently, there is no precedent for the application of the high pressure water jet system in the cutting construction of the rock-wall crane girders, and there is a lack of relevant instructions and specifications for the high pressure water jet construction process method of the rock-anchor girder.

### SUMMARY

In order to solve the deficiencies of the prior art, the present invention provides a high pressure water jet cutting apparatus and method for a rock-wall crane girder in an underground cavern powerhouse. It utilizes a water jet technology instead of blasting construction, reduces the safety problems and construction interference brought by the traditional drill-blasting method, and improves the construction quality and efficiency of the rock-wall crane girder.

In order to achieve the above-mentioned purpose, the present invention adopts the following technical solutions.

In a first aspect, the present invention provides a high pressure water jet cutting apparatus for a rock-wall crane girder in an underground cavern powerhouse.

A high pressure water jet cutting apparatus for a rock-wall crane girder in an underground cavern powerhouse, comprising at least: a guiding mechanism, a support mechanism, and a jet cutting mechanism; wherein,
the guiding mechanism is detachably connected to a steel tube frame, the steel tube frame is erected according to a drilling position, and the steel tube frame can be repeatedly built and used, which avoids a large amount of ground treatment work and material waste and reduces a cost; the support mechanism of the present invention is connected to the guiding mechanism and is capable of moving on the guiding mechanism, which is convenient for directional construction position movement; the present invention realizes plug-and-play during on-site construction through the detachable steel tube frame, a positioning steel tube, and a guiding structure; and each pillar of the steel tube frame of the present invention can be self-adjusted according to an unevenness degree of the ground to maintain the level of a support frame surface, thereby ensuring a horizontal arrangement of guide rails in the guiding mechanism; and
the support mechanism is connected to the jet cutting mechanism, and the support mechanism is configured to control an angle of a hollow jet pipeline protection tube of the jet cutting mechanism, and can realize horizontal automatic movement and focusing; a tail end of the hollow jet pipeline protection tube is connected with a nozzle for spraying, and the steel tube frame is connected with the positioning steel tube, and the positioning steel tube can guide the hollow jet pipeline protection tube to extend into a hole in a designed orientation for cutting work, improving construction accuracy.

In an implementation of the present invention, the nozzle is a bent-shaped nozzle, and an included angle between a vertical tube and a horizontal tube of the bent-shaped nozzle is greater than 90°, so that a spraying direction of the nozzle is offset by a set angle relative to a plane perpendicular to the vertical tube, which solves a problem that opposite jets emitted among high pressure nozzles affect a service life of the nozzles, and fully considers protection of the nozzles; and the angle of the nozzles is controllable and adjustable, which maximally avoids a situation that the opposite high pressure jets emitted among the nozzles directly spray onto the opposite nozzles, avoids wear and damage of the nozzles, and extends the service life of the nozzles.

Specifically, the bent-shaped nozzle of the present invention may be an L-shaped-like nozzle, a corner of the nozzle may be arc-shaped; and meanwhile, the offset herein is a relative concept, that is, the horizontal tube of the nozzle is offset downward by a set angle relative to the horizontal plane when the vertical tube of the nozzle is vertically arranged relative to the horizontal plane.

In an implementation of the present invention, execution control mechanisms of the guiding mechanism, the support mechanism, and the jet cutting mechanism are respectively in communication connection with an on-site control terminal; and the on-site control terminal is in communication with a remote controller through a wireless communication unit, and can be operated by utilizing wireless remote control in combination with each electric drive mechanism, so there is no need for people to contact closely, avoiding harm caused by the high pressure jets to people during a close-range operation.

In an implementation of the present invention, a horizontal adjustment mechanism is connected to the guiding mechanism, which can realize a horizontal adjustment of the guiding mechanism and ensure that the support mechanism is capable of moving horizontally.

The guiding mechanism of the present invention comprises at least: a first guide rail, a sliding part, and a first drive mechanism, wherein the first guide rail is detachably fixed to the steel tube frame, the steel tube frame is connected with a plurality of positioning steel tubes for the hollow jet pipeline protection tube to extend into, the sliding part is slidably connected to the first guide rail, the first drive mechanism is connected to the sliding part to drive the sliding part to move on the first guide rail, and the support mechanism is connected to the sliding part to move with the sliding part. The present invention utilizes on-site steel tubes to build a positioning steel tube frame and sets the first guide rail, and the first drive mechanism is set on the first guide rail to drive a jet mechanism to move, so that the jet mechanism is capable of moving smoothly and stably along a fixed direction of the first guide rail, and the first guide rail can make a movement path of the jet mechanism accurately controllable.

In the present invention, the steel tube frame, the positioning steel tubes, and the first guide rail are respectively used as modular units, the steel tube frame is detachably connected to the positioning steel tubes, and the first guide rail is detachably connected to the steel tube frame; and a modular design is adopted to realize plug-and-play and improve work efficiency.

In an implementation of the present invention, the support mechanism comprises at least: a second drive mechanism, a floating positioning mechanism, a third drive mechanism, and a rack; wherein,
the hollow jet pipeline protection tube is connected to the floating positioning mechanism, the floating positioning mechanism is connected to the second drive mechanism, a support of the second drive mechanism is movably connected to the rack, an output end of the third drive mechanism is connected to the support to adjust a working angle of the hollow jet pipeline protection tube, and the third drive mechanism is connected to the rack.

In the present invention, preferably, the third drive mechanism adopts an electric push rod, and a working angle of the jet cutting mechanism arranged on the support mechanism can be adjusted arbitrarily by utilizing the electric push rod, realizing horizontal automatic movement and focusing; and meanwhile, a second guide rail on the frame in a certain direction can be arranged according to a specific condition, and the jet cutting mechanism can realize vertical cutting and inclined cutting required in construction of a rock-anchor girder by adjusting arrangement of the second guide rail and a state of the electric push rod.

Through setting of the floating positioning mechanism in the present invention, a position of the hollow jet pipeline protection tube can be fine-adjusted in the plane, and the vertical movement of the hollow jet pipeline protection tube can be guided, so that the hollow jet pipeline protection tube extends into the positioning steel tubes and holes at an appropriate orientation and angle.

Furthermore, the floating positioning mechanism comprises at least a rear-end floating positioning mechanism, wherein the rear-end floating positioning mechanism is connected to a roller; wherein,
the rear-end floating positioning mechanism has two through-holes, which are respectively used for floating positioning of the two hollow jet pipeline protection tubes, wherein in each through-hole, a first base, a fixing plate, a first floating block, and a spring are arranged; and
the hollow jet pipeline protection tube passes through the fixing plate and is fixedly connected to the fixing plate, the fixing plate is fixedly connected to the first floating block, the first floating block is located in hollow space of the first base and is floatingly connected to an inner wall of the hollow space of the first base through the spring.

In an implementation of the present invention, the floating positioning mechanism also comprises a front-end floating positioning mechanism, the front-end floating positioning mechanism has two through-holes, wherein in each through-hole, a second base, a floating bearing, a second floating block, and a spring are arranged; the hollow jet pipeline protection tube passes through the floating bearing and is capable of reciprocating in the floating bearing; the floating bearing is embedded and fixed in the second floating block; and the second floating block is floatingly connected to an inner wall of a hollow space of the second base through the spring.

The floating positioning mechanisms on the two hollow jet pipeline protection tubes of this invention are relatively independent, so they can be adjusted separately; and angles and orientations of the two jet-protecting steel tubes can be adjusted immediately through the floating positioning mechanisms respectively when there are small differences in spacing and angle of the different positioning steel tubes into which the two hollow jet pipeline protection tubes be extended, so that the protecting steel tubes can be respectively extended into the holes at appropriate angles for work, avoiding the problem that the jet-protecting steel tubes get stuck in the holes.

In an implementation of the present invention, the jet cutting mechanism comprises a first jet cutting mechanism and a second jet cutting mechanism, wherein the first jet cutting mechanism and the second jet cutting mechanism both comprise: a nozzle and a hollow jet pipeline protection tube connected to the nozzle; wherein,

the nozzle is connected to a high pressure water jet pump set through a high pressure water pipeline, and the nozzle is connected to a sand-feeding mechanism through a sand-conveying pipeline; and the two nozzles of the first jet cutting mechanism and the second jet cutting mechanism are arranged opposite to each other for opposite cutting.

In an implementation of the present invention, the cutting apparatus further comprises a dust-collecting system; the dust-collecting system comprises: a dust-removing cover, a dust-collecting pipeline, and an industrial vacuum cleaner, wherein the dust-removing cover is in a horn shape, there are reserved hole openings in a center and at a side of the dust-removing cover, the sizes of the hole openings are consistent with an outer diameter of the hollow jet pipeline protection tube and an inner diameter of the dust-collecting pipeline respectively; and the dust-removing cover is sleeved on the jet-protecting tube in the jet cutting mechanism through the reserved hole opening in the center, and the dust-collecting pipeline connects the dust-removing cover and the industrial vacuum cleaner through the reserved hole opening at the side of the dust-removing cover; and the dust-removing cover can be closely attached to a tube mouth of the positioning steel tube during construction, so that dust and smoke generated by cutting are both confined in holes below the dust-removing cover, and the dust-removing cover is connected to the industrial vacuum cleaner, thus sucking away the dust below the dust-removing cover by the vacuum cleaner, keeping a construction environment clean and avoiding influence of the dust.

In a second aspect, the present invention provides a working method for the high pressure water jet cutting apparatus for a rock-wall crane girder in an underground cavern powerhouse, wherein the method utilizes at least one high pressure water jet cutting apparatus for a rock-wall crane girder in an underground cavern powerhouse as described in the first aspect of the present invention, and comprises the following processes:
the guiding mechanism guides the movement of the support mechanism; and the support mechanism adjusts a working orientation and angle of a jet-protecting steel tube in the jet cutting mechanism, so that the jet-protecting steel tube is extended into holes along the positioning steel tube, and the jet cutting mechanism emits high pressure jets for the cutting construction; and
working parameters of the jet cutting mechanism are adjusted according to data of various sensing elements on the support mechanism, wherein the sensing elements comprise at least a force-sensing element and an inclination-sensing element, and the working parameters comprise at least a moving speed and a spraying pressure.

Compared with the prior art, the beneficial effects of the present invention are as follows:
1. The present invention fully considers that the movement mode of the jet mechanism greatly affects the construction quality accuracy, construction efficiency, and on-site cost control, utilizes the on-site steel tubes to build the positioning steel tube frame and sets up the guide rails, wherein the belt drive mechanism is arranged on the guide rails to drive the jet mechanism to move, enabling the jet mechanism to move smoothly and stably along the fixed guide rail direction; the guide rails make the movement path of the jet mechanism precisely controllable, and meanwhile, the positioning steel tubes may guide the jet mechanism to extend into the holes at the designed orientation for the cutting work, improving the construction accuracy, wherein the steel tube frame may be repeatedly built and used, avoiding a large amount of ground treatment work and material waste, thus reducing costs; the present invention utilizes the modular design, and the base part are split into three modules: the steel tube frame, the positioning steel tubes, and the guide rails, which realizes the plug-and-play; in addition, each pillar of the steel tube frame can adapt to the unevenness of the ground to adjust and maintain the level of the support surface; and meanwhile, utilizing a motor and a belt for driving can greatly reduce labor intensity and realize mechanization of the construction process, improving the construction efficiency.
2. The present invention fully considers the applicability of the jet cutting mechanism for cutting work at different angles and ease of operation of the apparatus, and utilizes the sensors and a feedback mechanism and the electric push rod mounted on the support mechanism, which can arbitrarily adjust the working angle of the jet cutting mechanism mounted on the support mechanism, and realizes the horizontal automatic movement and focusing; and meanwhile, the guide rail on the frame in the certain direction can be arranged according to the specific condition, and the jet cutting mechanism can realize the vertical cutting and the inclined cutting required in the construction of the rock-anchor girder by adjusting the arrangement of the guide rail and the state of the electric push rod.
3. To solve the technical problems that the jet protection steel tube is difficult to be accurately extended into the holes for the cutting work and is prone to getting stuck in the holes, the present invention fully considers the adjustment requirements when the jet protection steel tube is extended into the steel tube, arranges the rear-end floating positioning mechanism and the front-end floating positioning mechanism on the support mechanism, which can finely adjust the position of the jet protection steel tube of the jet cutting mechanism in the plane and guide the jet protection steel tube to move in the vertical direction, enabling the jet protection steel tube to be extended into the positioning steel tubes and the holes at the appropriate orientation and angle; and meanwhile, the floating positioning mechanism on the two jet protection steel tubes are relatively independent and capable of being adjusted separately, and when there are slight differences in the spacing and angles among the different positioning steel tubes into which the two jet protection steel tubes are extended, the angles and orientations of the two jet protection steel tubes can be immediately and finely adjusted through the floating positioning mechanism, allowing the protection steel tubes to be extended into the holes at appropriate angles for work and avoiding the problem of the jet protection steel tubes getting stuck in the holes.
4. Considering actual construction needs, the present invention designs the novel L-shaped nozzle to achieve lateral cutting; to solve the problem that the opposite jets emitted among the high pressure nozzles affect the service life of the nozzles, the present invention fully considers the protection of the L-shaped nozzle, wherein the jet direction of the high pressure nozzle is inclined downward at a certain angle from the horizontal direction, and the angle of the nozzle is controllable and adjustable, which can avoid, to a greatest extent, the opposite high pressure jets emitted among the nozzles from directly spraying onto the opposite nozzles, prevent the wear and damage of the nozzles and prolong the service life of the nozzles.
5. To solve the problems that dust generated at a jet construction site can obstruct a line of sight, affect the construction efficiency, and endanger the life and health of the construction worker, the present invention fully considers blocking and removal of the dust generated during the construction; the dust-removing cover that can adjust its position along the steel tube direction is sleeved on the jet protection steel tube of the jet cutting mechanism, and the dust-removing cover can be made to closely adhere to the tube mouth of the positioning steel tube during the construction, which confines all the dust generated by cutting within the holes below the dust-removing cover; and the dust-removing cover is connected to the industrial vacuum cleaner, so that the dust below the dust-removing cover can be sucked away by the vacuum cleaner, keeping the construction environment clean and avoiding the influence of the dust.
6. The present invention fully considers a potential threat of huge power of high pressure jets to personnel, utilizes various automatic actuators in the design, and sets up a plurality of protection measures; the movement and operation of the jet mechanism are all driven by the belt drive mechanism, and wireless remote control operation may be adopted, eliminating the need for personnel to be in close contact and avoiding injury to personnel caused by the high pressure jets during the close-range operation; all pipelines are made of ultra-high pressure resistant pipelines, pipeline protection sleeves are designed at all pipeline interfaces, and personnel wear protective work clothes during operation; and the plurality of lines of defense can effectively prevent the high pressure water jets from endangering the life safety of personnel and ensure the safety of the construction process.
7. The present invention proposes a construction process method for cutting a rock anchor girder of an underground cavern powerhouse utilizing the high pressure water jets; according to a workload or cost budget, a plurality of jet cutting mechanisms may be arranged for joint operation; and in addition, by utilizing perception of parameters such as vibration and reaction force and matching a corresponding intelligent control algorithm, in-hole feed parameters such as a water pressure and moving speed may be automatically adjusted, which realizes the remote and intelligent control of the entire system.
8. The present invention fully considers the limitations of traditional blasting construction methods, reduces the safety problems and construction interference caused by the traditional drill-blasting methods through proposing the application of the water jet cutting, improves the construction quality and efficiency of the rock-wall crane girder, and provides equipment support for promoting the development and engineering application of the water jet technology in the field of water conservancy and hydropower engineering technology; and the structure of the present invention is reasonably designed, and the construction method is simple and feasible, with a high application value.

Additional advantages of the present invention will be partly given in the following description, and partly become obvious from the following description, or be understood through the practice of the present invention.

### BRIEF DESCRIPTION OF THE DRAWINGS

The accompanying drawings, which form a part of the present invention, are used to provide a further understanding of the present invention. The schematic embodiments of the present invention and their descriptions are used to explain the present invention and do not constitute an improper limitation of the present invention.

FIG. 1 is a schematic diagram of an overall structure of a high pressure water jet cutting apparatus for a rock-wall crane girder in an underground cavern powerhouse provided by the present invention;

FIG. 2 is a structural schematic diagram of a steel tube frame and a guiding mechanism provided by the present invention;

FIG. 3 is a structural schematic diagram of a support mechanism and a jet cutting mechanism provided by the present invention;

FIG. 4 is a partial cross-sectional view of a flow-dividing mechanism in a jet cutting mechanism provided by the present invention;

FIG. 5 is a partial schematic diagram of a high pressure nozzle in a jet cutting mechanism provided by the present invention;

FIG. 6 is a schematic diagram of cutting work of a water jet cutting apparatus provided by the present invention;

FIG. 7 is a structural schematic diagram of a nozzle provided by the present invention;

FIG. 8 is a schematic diagram of a vertical cutting solution of a water jet cutting apparatus provided by the present invention; and

FIG. 9 is a schematic diagram of an inclined cutting solution of a water jet cutting apparatus provided by the present invention.

Where in the figures:
1, high pressure water jet pump set; 2, sand-feeding mechanism; 3, sand-conveying pipeline; 4, high pressure water pipeline; 5, steel tube frame; 6, guiding mechanism; 7, support mechanism; 8, jet cutting mechanism; 9, dust-removing cover; 10, dust-collecting pipeline; 11, industrial vacuum cleaner;
51, support steel tube; 52, drilling positioning steel tube;
61, horizontal adjustment mechanism; 62, guide rail; 63, slider; 64, belt drive mechanism; 641, belt; 642, motor; 643, fixing support; 644, pulley;
71, Z-axis drive mechanism; 711, Z-axis support; 712, pulley; 713, Z-axis guide rail; 714, roller; 715, motor support; 716, motor;
72, floating positioning mechanism; 721, rear-end floating positioning mechanism; 722, front-end floating positioning mechanism; 73, hollow jet pipeline protection tube; 74, drag chain; 75, electric push rod; 76, rack; 761, support square tube; 762, roller; 77, dust-collecting apparatus; 78, L-shaped high pressure nozzle; 781, high pressure water pipeline connector; 782, sand-conveying pipeline connector;
7211, first base; 7212, cover plate; 7213, guide positioning screw; 7214, fixing plate; 7215, first floating block; 7216, spring; 7217, jack screw;
7221, second base; 7222, cover plate; 7223, guide positioning screw; 7224, floating bearing; 7225, second floating block; 7226, spring.

### DESCRIPTION OF THE EMBODIMENTS

The present invention will be further described below in conjunction with the accompanying drawings and embodiments.

It should be noted that the following detailed descriptions are all exemplary and aim to provide further explanations of the present invention. Unless otherwise specified, all technical and scientific terms used herein have the same meanings as commonly understood by those of ordinary skill in the technical field to which the present invention belongs.

In a case of no conflict, the embodiments of the present invention and features in the embodiments can be combined with each other.

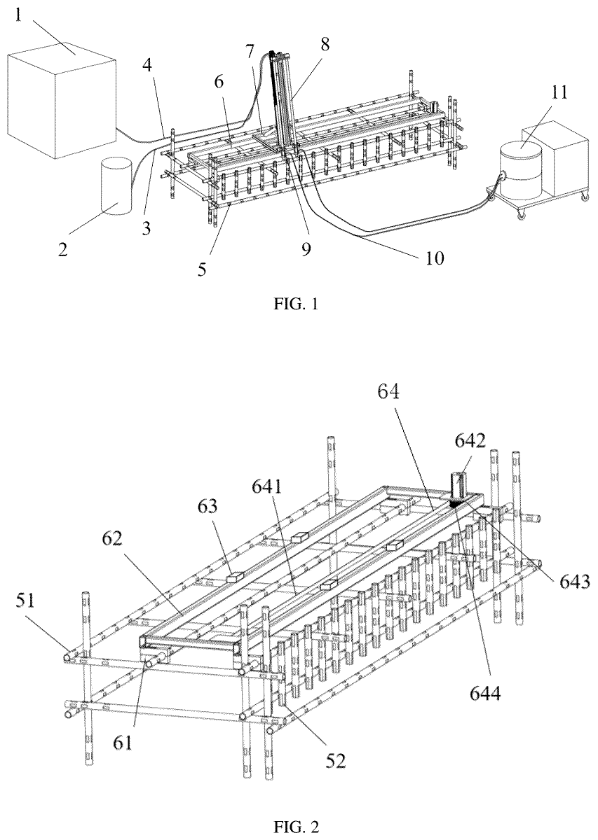

In an implementation, a high pressure water jet cutting apparatus for a rock-wall crane girder in an underground cavern powerhouse is proposed. As shown in FIG. 1, it comprises a high pressure water jet pump set 1, a sand-feeding mechanism 2, a sand-conveying pipeline 3, a high pressure water pipeline 4, a steel tube frame 5, a guiding mechanism 6, a support mechanism 7 (used to support the jet cutting mechanism 8), a jet cutting mechanism 8, a dust-removing cover 9, a dust-collecting pipeline 10, and an industrial vacuum cleaner 11.

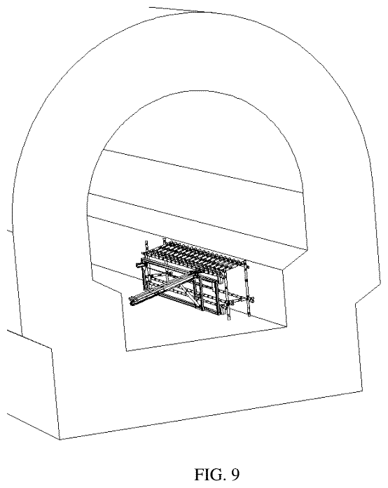

More specifically, as shown in FIG. 8 and FIG. 9, which are schematic diagrams of its specific usage states, the guiding mechanism 6 is arranged using the steel tube frame 5 set up on-site according to drilling positions. The support mechanism 7 is arranged above the guiding mechanism 6. The guiding mechanism 6 can guide a movement path of the support mechanism 7. An upper end of the support mechanism 7 is connected to support the jet cutting mechanism 8 and a working orientation and angle of the jet protection steel tube in the jet cutting mechanism 8 can be adjusted, enabling the hollow jet pipeline protection tube to be smoothly extended into a hole for work and solving a problem of precise orientation adjustment of the hollow jet pipeline protection tube. The jet cutting mechanism 8 can emit high pressure jets for cutting construction.

As shown in FIG. 2, the steel tube frame 5 comprises support steel tubes 51 and drilling positioning steel tubes 52. The guiding mechanism 6 is arranged on the steel tube frame 5. The guiding mechanism 6 comprises a horizontal adjustment mechanism 61, X-direction guide rail 62 (i.e., first guide rail), sliders 63 (i.e., sliding parts), and a belt drive mechanism 64 (i.e., a first drive mechanism).

In the present example, preferably, the horizontal adjustment mechanism 61 is arranged between the guide rail 62 (i.e., the first guide rail) and the steel tube frame 5 and can adjust a horizontal orientation of the guide rail 62 (i.e., the first guide rail).

In the present example, more specifically, the sliders 63 (i.e., the sliding parts) are located between the guide rail 62 (i.e., the first guide rail) and the support mechanism 7 and can assist the movement of the support mechanism 7 on the guide rail 62 (i.e., the first guide rail) and reduce friction.

In the present example, preferably, the belt drive mechanism 64 (i.e., the first drive mechanism) comprises a belt 641 (i.e., a first belt), a motor 642 (i.e., a first motor), a fixing support 643, and a pulley 644 (i.e., a first pulley). The sliders 63 (i.e., the sliding parts) are driven by the belt drive mechanism 64 (i.e., the first drive mechanism) and moves in the X-direction along the guide rail 62 (i.e., the first guide rail). In the present example, the X-direction refers to an arrangement direction of the guide rail 62 (i.e., the first guide rail). A direction perpendicular to the X-direction in a horizontal plane is a Y-direction, and a direction perpendicular to the horizontal plane or at a set included angle is a Z-direction.

In the present example, more specifically, the belt drive mechanism 64 (i.e., the first drive mechanism) is arranged along a path of the guide rail 62 (i.e., the first guide rail). Driven by the motor 642 (i.e., the first motor), the belt 641 (i.e., the first belt) can pull the support mechanism 7 on the guide rail 62 (i.e., the first guide rail) to move along the path of the guide rail 62 (i.e., the first guide rail) with the assistance of the sliders 63 (i.e., the sliding parts).

More specifically, the steel tube frame 5 in the present example is erected according to on-site drilling positions. The sliders 63 (i.e., the sliding parts) are slidably connected to the guide rail 62 (i.e., the first guide rails). The support mechanism 7 is connected to the sliders 63 (i.e., the sliding parts) to move with the sliders 63. The motor 642 (i.e., the first motor) is connected to a frame where the guide rail 62 (i.e., the first guide rail) is located through the fixing support 643. An output shaft of the motor 642 (i.e., the first motor) is connected to the pulley 644 (i.e., the first pulley). The belt 641 (i.e., the first belt) is sleeved on the outside of the pulley 644 (i.e., the first pulley) and rotates under drive of the pulley 644 (i.e., the first pulley) to pull the support mechanism 7 to move along the guide rail 62 (i.e., the first guide rail) through the sliders 63 (i.e., the sliding parts).

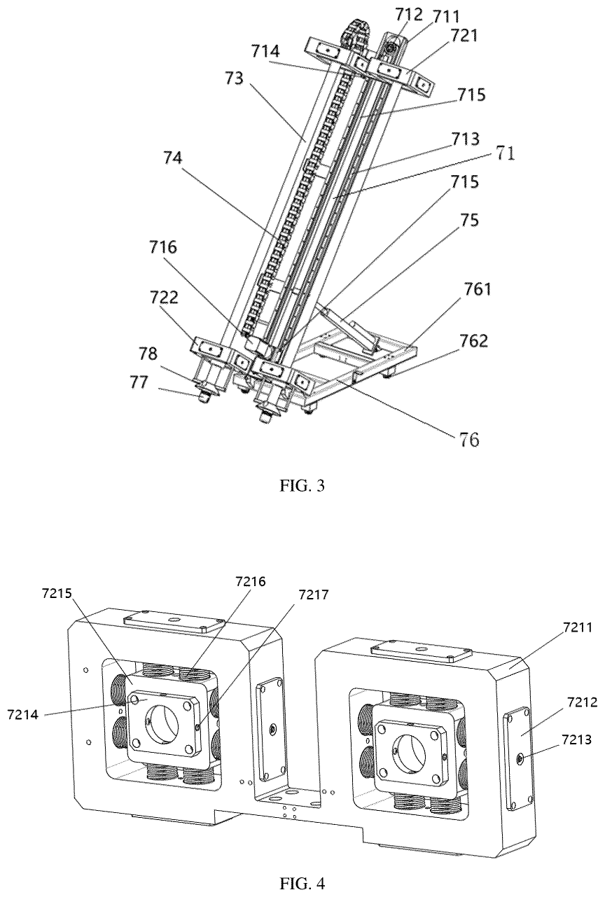

As shown in FIG. 3, the support mechanism 7 comprises: a Z-axis drive mechanism 71, a floating positioning mechanism, a drag chain 74, an electric push rod 75, a rack 76, and a dust-collecting cover 77.

In the present example, preferably, the Z-axis drive mechanism 71 comprises: a Z-axis support 711, a pulley 712 (i.e., a second pulley), a guide rail 713 (i.e., a second guide rail), a roller 714, a belt 715 (i.e., a second belt), and a motor 716 (i.e., a second motor).

The hollow jet pipeline protection tube 73 is connected to the roller 714 through the floating positioning mechanism 72, and the roller 714 is slidably connected to the guide rail 713 (i.e., the second guide rail).

The motor 716 (i.e., the second motor) is connected to the Z-axis support 711, an output shaft of the motor 716 (i.e., the second motor) is connected to the pulley 712 (i.e., the second pulley), and the belt 715 (i.e., the second belt) is sleeved on the pulley 712 (i.e., the second pulley) to drive the roller 714 to move on the guide rail 713 (i.e., the second guide rail). The Z-axis support 711 is movably connected to the rack 76 (preferably, the movable connection herein is a hinge joint, or other shaft connections can also be used, etc.). The L-shaped high pressure nozzle 78 is threadedly connected to the hollow jet pipeline protection tube 73.

Both the high pressure water pipeline 4 and the water supply pipeline 3 partially penetrate into the hollow jet pipeline protection tube 73. The high pressure water pipeline 4 connects the L-shaped high pressure nozzle 78 and the high pressure water jet pump set 1, and the sand-conveying pipeline 3 connects the L-shaped high pressure nozzle 78 and the sand-feeding mechanism 2. More specifically, the high pressure water pipeline interface 781 of the L-shaped high pressure nozzle 78 is connected to the high pressure water pipeline 4, the sand-conveying pipeline interface of the L-shaped high pressure nozzle 78 is connected to the sand-conveying pipeline 3, and an angle between a vertical tube and a horizontal tube of the L-shaped high pressure nozzle 78 is greater than 90°.

The apparatus in the present example further comprises a dust-collecting system. The dust-collecting system comprises a dust-removing cover 77, a dust-collecting pipeline 10, and an industrial vacuum cleaner 11. The dust-removing cover 77 is in a horn shape, and there are reserved hole openings at a center and side of the dust-removing cover 77. Sizes of the hole openings are consistent with an outer diameter of the hollow jet pipeline protection tube 73 and an inner diameter of the dust-collecting pipeline 10 respectively.

The dust-removing cover 77 is placed on the hollow jet pipeline protection tube 73 through the reserved hole opening at the center, and the dust-collecting pipeline 10 connects the dust-removing cover 77 and the industrial vacuum cleaner 11 through the reserved hole opening at the side of the dust-removing cover 77, so that an area below the dust-removing cover 77 is within a working range of the industrial vacuum cleaner 11 for a dust-removing operation.

In the present example, preferably, the floating positioning mechanism 72 comprises a rear-end floating positioning mechanism 721 and a front-end floating positioning mechanism 722, the rack 76 comprises a square tube 761 and a roller 762, and the L-shaped high pressure nozzle 78 is threadedly connected to the hollow jet pipeline protection tube 73.

In the present example, preferably, the dust-collecting cover 77 is fixedly connected to the front-end floating positioning mechanism 722, the front-end floating positioning mechanism 722 is fixed at a lower end of the Z-axis drive mechanism 71, the rear-end floating positioning mechanism 721 and the Z-axis drive mechanism 71 achieve Z-axis movement through a connection with the roller 714, the Z-axis drive mechanism 71 is connected to the rack 76 through a rotating shaft, and the electric push rod 75 is respectively connected to the Z-axis drive mechanism 71 and the rack 76 through hinge joints (more specifically, tail ends of the electric push rod 75 are respectively connected to the Z-axis support 711 and the rack 761 through the hinge joints). The movement of the electric push rod 75 realizes angle adjustment of the Z-axis drive mechanism 71 to meet the cutting of the rock-wall crane girders at different angles.

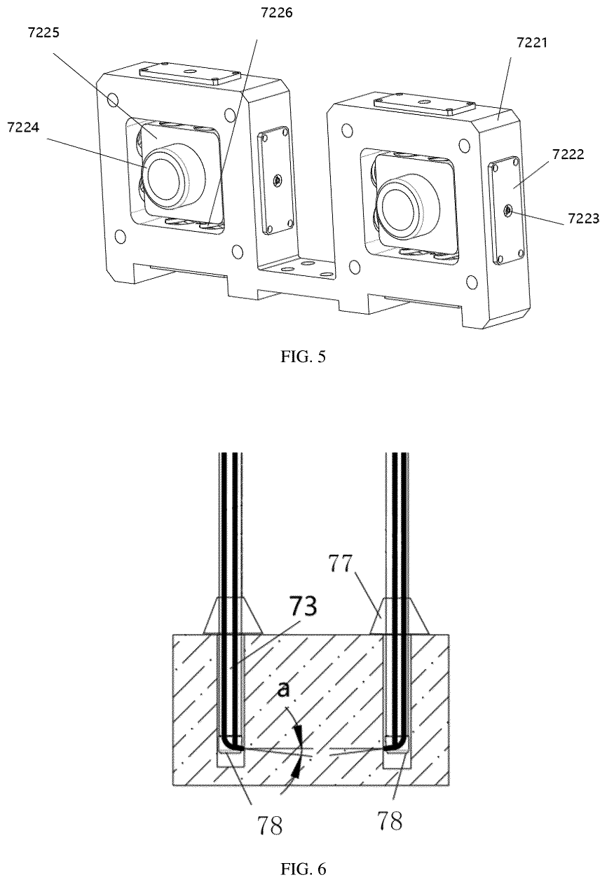

As shown in FIG. 4, the rear-end floating positioning mechanism 721 comprises: a first base 7211, a cover plate 7212, a guide positioning screw 7213, a fixing plate 7214, a first floating block 7215, a spring 7216, and a jack screw 7214. The cover plate 7212 is connected to the first base 7211 through the guide positioning screw 7213, the hollow jet pipeline protection tube 73 is fixedly connected to the fixing plate 7214 through the jack screw 7217, the fixing plate is connected to the first floating block 7215, and the first floating block 7215 is floatingly connected to an inner side wall of hollow space (through-hole space that can accommodate the first floating block 7215 and the spring 7216) of the first base 7211 through the spring 7216.

As shown in FIG. 5, the front-end floating positioning mechanism 722 comprises: a second base 7221, a cover plate 7222, a guide positioning screw 7223, a floating bearing 7224, a second floating block 7225, and a spring 7226. The hollow jet pipeline protection tube 73 reciprocates in the floating bearing 7224, the cover plate 7222 is connected to the second base 7221 through the guide positioning screw 7223, and the second floating block 7225 is floatingly connected to an inner side wall of hollow space (through-hole space that can accommodate the second floating block 7225 and the spring 7226) of the second base 7221 through the spring 7226.

In the present example, preferably, there are two hollow jet pipeline protection tubes 73, and there are also two groups of the corresponding first floating blocks 7215 and the second floating blocks 7225 respectively.

As shown in FIG. 3, FIG. 4, and FIG. 5, the floating positioning mechanism 72 enables the hollow jet pipeline protection tube 73 to perform floating feed during the reciprocating movement along the Z-axis direction, which solves the problem of inaccurate positioning of early air gun drilling.

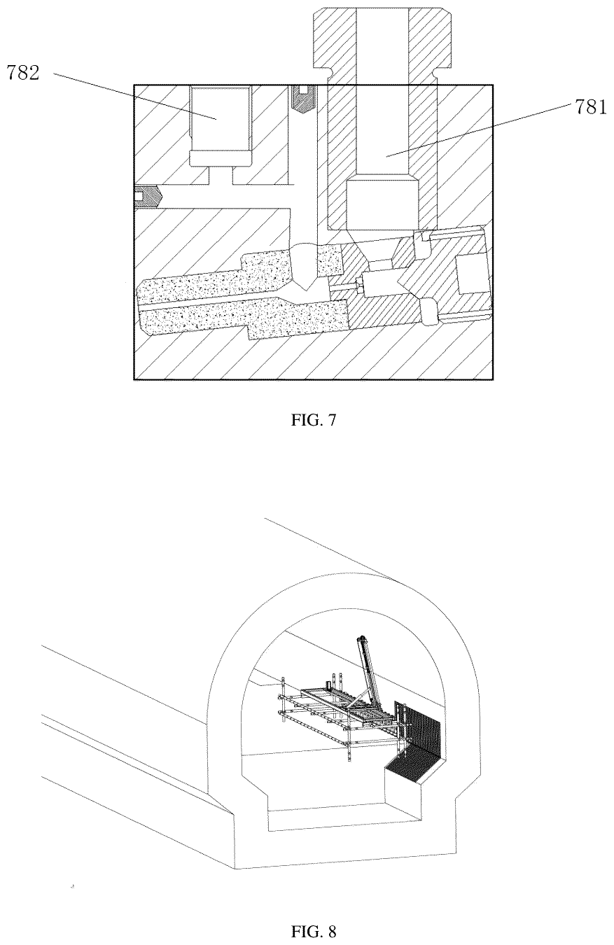

As shown in FIG. 6 and FIG. 7, a jet direction of the L-shaped high pressure nozzle 78 forms a certain included angle α with the horizontal direction, which solves a problem of excessive wear of the nozzle caused by jetting towards the opposite nozzles during the opposite jetting process of the nozzles.

In the present example, preferably, the drag chain 74 is arranged on the Z-axis support along the direction of the guide rail 713 (i.e., the second guide rail) and is connected to one of the hollow jet pipeline protection tubes 73, which can assist in guiding axial movement of the hollow jet pipeline protection tube 73.

The above are only the preferred embodiments of the present invention and are not intended to limit the present invention. For those skilled in the art, the present invention may have various modifications and changes. Any modification, equivalent replacement, improvement, etc. made within the spirit and principle of the present invention shall be comprised in the protection scope of the present invention.

1. A high pressure water jet cutting apparatus for a rock-wall crane girder in an underground cavern powerhouse, comprising at least: a guiding mechanism, a support mechanism, and a jet cutting mechanism, wherein
the guiding mechanism is detachably connected to a steel tube frame which is erected according to drilling positions, and the support mechanism is connected to the guiding mechanism and is capable of moving on the guiding mechanism;
the support mechanism is connected to the jet cutting mechanism, the support mechanism is configured to adjust an angle of a hollow jet pipeline protection tube of the jet cutting mechanism, a tail end of the hollow jet pipeline protection tube is connected to a nozzle, and the steel tube frame is connected to a positioning steel tube through which the hollow jet pipeline protection tube passes;
the nozzle is a bent-shaped nozzle, and an included angle between a vertical tube and a horizontal tube of the bent-shaped nozzle is greater than 90°, so that a jet direction of the nozzle is offset by a set angle relative to a plane perpendicular to the vertical tube;
the support mechanism at least comprises: a second drive mechanism, a floating positioning mechanism, a third drive mechanism, and a rack;
the hollow jet pipeline protection tube is connected to the floating positioning mechanism, the floating positioning mechanism is connected to the second drive mechanism, a support of the second drive mechanism is movably connected to the rack, an output end of the third drive mechanism is connected to the support to adjust a working angle of the hollow jet pipeline protection tube, and the third drive mechanism is connected to the rack; and
the floating positioning mechanism comprises a rear-end floating positioning mechanism and a front-end floating positioning mechanism, there are two hollow jet pipeline protection tubes, and there are two groups of corresponding floating positioning mechanisms, and the two groups of floating positioning mechanisms are relatively independent and are capable of being adjusted respectively.

2. The high pressure water jet cutting apparatus for the rock-wall crane girder in the underground cavern powerhouse according to claim 1, wherein
execution control mechanisms of the guiding mechanism, the support mechanism, and the jet cutting mechanism are respectively in communication connection with an on-site control terminal; and the on-site control terminal is in communication with a remote controller through a wireless communication unit.

3. The high pressure water jet cutting apparatus for the rock-wall crane girder in the underground cavern powerhouse according to claim 1, wherein
a horizontal adjustment mechanism is connected to the guiding mechanism, and the guiding mechanism at least comprises: a first guide rail, a sliding part, and a first driving mechanism, wherein
the first guide rail is detachably fixed to the steel tube frame, the steel tube frame is connected with a plurality of positioning steel tubes for the hollow jet pipeline protection tube to extend into, the sliding part is slidably connected to the first guide rail, the first drive mechanism is connected to the sliding part to drive the sliding part to move on the first guide rail, and the support mechanism is connected to the sliding part to move with the sliding part.

4. The high pressure water jet cutting apparatus for the rock-wall crane girder in the underground cavern powerhouse according to claim 3, wherein
the steel tube frame, the positioning steel tubes, and the first guide rail are respectively used as modular units, the steel tube frame is detachably connected to the positioning steel tubes, and the first guide rail is detachably connected to the steel tube frame.

5. The high pressure water jet cutting apparatus for the rock-wall crane girder in the underground cavern powerhouse according to claim 1, wherein
the rear-end floating positioning mechanism is connected to a roller;
the rear-end floating positioning mechanism has two through-holes, which are respectively used for floating positioning of the two hollow jet pipeline protection tubes, wherein in each through-hole, a first base, a fixing plate, a first floating block, and a spring are arranged; and
the hollow jet pipeline protection tube passes through the fixing plate and is fixedly connected to the fixing plate, the fixing plate is fixedly connected to the first floating block, the first floating block is located in hollow space of the first base and is floatingly connected to an inner wall of the hollow space of the first base through the spring.

6. The high pressure water jet cutting apparatus for the rock-wall crane girder in the underground cavern powerhouse according to claim 5, wherein
the front-end floating positioning mechanism has two through-holes, wherein in each through-hole, a second base, a floating bearing, a second floating block and a spring are arranged; and
the hollow jet pipeline protection tube passes through the floating bearing and is capable of reciprocating in the floating bearing, the floating bearing is embedded and fixed in the second floating block, and the second floating block is floatingly connected to an inner wall of a hollow space of the second base through the spring.

7. The high pressure water jet cutting apparatus for the rock-wall crane girder in the underground cavern powerhouse according to claim 1, wherein
the jet cutting mechanism comprises a first jet cutting mechanism and a second jet cutting mechanism, wherein the first jet cutting mechanism and the second jet cutting mechanism both comprise: a nozzle and a hollow jet pipeline protection tube connected to the nozzle; and
the nozzle is connected to a high pressure water jet pump set through a high pressure water pipeline, and the nozzle is connected to a sand-feeding mechanism through a sand-conveying pipeline; and the two nozzles of the first jet cutting mechanism and the second jet cutting mechanism are arranged opposite to each other for opposite cutting.

8. The high pressure water jet cutting apparatus for the rock-wall crane girder in the underground cavern powerhouse according to claim 1, wherein
the cutting apparatus further comprises a dust-collecting system, and the dust-collecting system comprises a dust-removing cover, a dust-collecting pipeline, and an industrial vacuum cleaner, wherein the dust-removing cover is in a horn shape, there are reserved hole openings at a center and side of the dust-removing cover, and sizes of the hole openings are consistent with an outer diameter of the hollow jet pipeline protection tube and an inner diameter of the dust-collecting pipeline respectively; and
the dust-removing cover is sleeved on a jet protection tube of the jet cutting mechanism through the reserved hole opening at the center, and the dust-collecting pipeline connects the dust-removing cover and the industrial vacuum cleaner through the reserved hole opening at the side of the dust-removing cover.

9. A working method for the high pressure water jet cutting apparatus for a rock-wall crane girder in an underground cavern powerhouse, wherein the method utilizes the high pressure water jet cutting apparatus for a rock-wall crane girder in an underground cavern powerhouse according to claim 1, and comprises the following processes:
the guiding mechanism guides the movement of the support mechanism; and the support mechanism adjusts a working orientation and angle of a jet-protecting steel tube in the jet cutting mechanism, so that the jet-protecting steel tube is extended into holes along the positioning steel tube, and the jet cutting mechanism emits high pressure jets for the cutting construction; and
working parameters of the jet cutting mechanism are adjusted according to data of various sensing elements on the support mechanism, wherein the sensing elements comprise at least a force-sensing element and an inclination-sensing element, and the working parameters comprise at least a moving speed and a spraying pressure.
